(19) United States
(12) Patent Application Publication
(10) Pub. No.: US 2015/0167919 A1
(43) Pub. Date: Jun. 18, 2015

(54) Vehicle Lamp Assembly

(71) Applicant: Ford Global Technologies, LLC, Dearborn, MI (US)

(72) Inventors: Muhammed Aqil Hamid, Canton, MI (US); Venkatesh Krishnan, Canton, MI (US)

(73) Assignee: Ford Global Technologies, LLC, Dearborn, MI (US)

(21) Appl. No.: 14/109,018

(22) Filed: Dec. 17, 2013

(51) Int. Cl. F21S 8/10; F21V 7/20

(52) U.S. Cl. CPC F21S 48/238; F21V 7/20

(57) ABSTRACT

A lamp assembly having an area of heat concentration is provided with a conductive surface such as an aluminized coating or an insert that increases the emission of heat from the area of heat concentration. An absorptive surface is applied within the housing or on the bezel to increase thermal absorption at a location disposed above the area of heat concentration. Convective air flow within the lamp assembly is induced between the conductive surface to the absorptive surface. Methods disclosed include applying the conductive surface to the area of heat concentration and applying an absorptive surface coating within the lamp assembly.

### TECHNICAL FIELD

This disclosure relates to vehicle lamp assemblies with improved control of surface heat.

### BACKGROUND

Exterior lamp assemblies for vehicles generally include a housing, light sources, bezels, reflectors, lenses, and power sources. Depending upon the design of the lamp assembly and the location of light sources and power sources, localized areas on the components may have “hot spots” where extremely high temperatures exceeding 200° C. develop. Lamp components made of thermoset or thermoplastic polymers can be adversely affected by such high temperatures.

One approach to reducing hot spots is to add heat sinks to lamp components but this approach adds substantial weight to the assembly. Other changes may be made in lamp structure that may increase the cost of the lamp assembly. Changes in lamp design are limited by styling and packaging considerations. Problems relating to hot spots are frequently not discovered until late in the design process after prototype and production lamp assemblies are tested.

This disclosure is directed to the above problems and other problems as summarized below.

### SUMMARY

According to one aspect of this disclosure, a vehicle lamp assembly is provided that comprises a lamp housing, a light source disposed within the housing and a power source operatively connected to the light source within the housing. The housing encloses a reflector or other component that is provided with a conductive surface positioned on a heated surface having an area of heat concentration in the assembly. The conductive surface has a thermal emissivity ratio of more than the inherent thermal emissivity of the material forming the heated surface. An absorptive surface may be provided on a cooler surface above the conductive surface within the housing. The absorptive surface has an absorptivity ratio of more than the inherent absorptivity of the material forming the cooler surface and may be spaced apart from the conductive surface.

According to other aspects of this disclosure, the absorptive surface may be a flat black paint coating. In some embodiments, the absorptive surface may have an absorptivity ratio of at least 0.8 and may be more than 0.95.

The conductive surface may be an aluminized coating. Alternatively, in some embodiments, the conductive surface may be a metal or plastic insert or overlay. The conductive surface may have thermal conductivity more than 0.75 and may be more than 0.9. The insert or overlay may have thermal conductivity of at least 0.9 watts per meter Coulomb.

According to further aspects of this disclosure, a reflector may be disposed within the housing and the conductive surface may be located on an opposite side of the reflector from the light. The light source and the power source may be supported by the reflector and are likely to be the primary source of heat for the area of heat concentration. The absorptive surface may be located on an inside surface of the housing or bezel.

The conductive surface and the absorptive surface may be positioned to create air circulation within the housing to reduce the temperature in the area of heat concentration by convective heat transfer. The convective heat transfer creates a convective air flow by passive radiation heat transfer during operation of the light source to reduce the temperature at the area of heat concentration.

According to another aspect of this disclosure, a method is provided for reducing a temperature of a hot surface defining an area of heat concentration in a lamp assembly that includes a lamp housing, a light source and a reflector. The method comprises providing a thermally conductive surface having thermal emissivity of more than the thermal emissivity of the material forming the hot surface.

According to other aspects of the method, the conductive surface may be an aluminized surface coating. The aluminized surface coating may have thermal emissivity of more than 0.75. The conductive surface may be an insert having thermal conductivity of at least 0.9 watts per meter Coulomb.

The method may further comprise providing an absorptive surface having absorptivity of more than 0.8 that may be located above the conductive surface. The absorptive surface may be spaced apart from the conductive surface. The absorptive surface may be provided by applying a flat black paint coating to a surface within the housing.

According to another aspect of this disclosure, a method of reducing an area of heat concentration in a lamp assembly is provided that comprises providing an absorptive surface having absorptivity greater than the inherent absorptivity of the material forming a cooler surface within the housing than an area of heat concentration. The cooler surface may be disposed above the area of heat concentration.

The method may also comprise illuminating the light source to create convective air flow within the lamp assembly using passive radiation heat transfer to reduce the temperature of the area of heat concentration.

The above aspects of the disclosure and other aspects are described in greater detail below with reference to the attached drawings.

### BRIEF DESCRIPTION OF THE DRAWINGS

FIG. 1 is a fragmentary perspective view of the front end of a vehicle showing a lamp assembly;

FIG. 2 is a fragmentary cross-sectional view of a lamp assembly;

FIG. 3 is a simulated temperature profile of a lamp assembly having high heat concentration; and

FIG. 4 is a simulated temperature profile of a lamp assembly having a thermally conductive surface disposed at an area of high heat concentration to increase convective heat transfer away from the area of high heat concentration.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

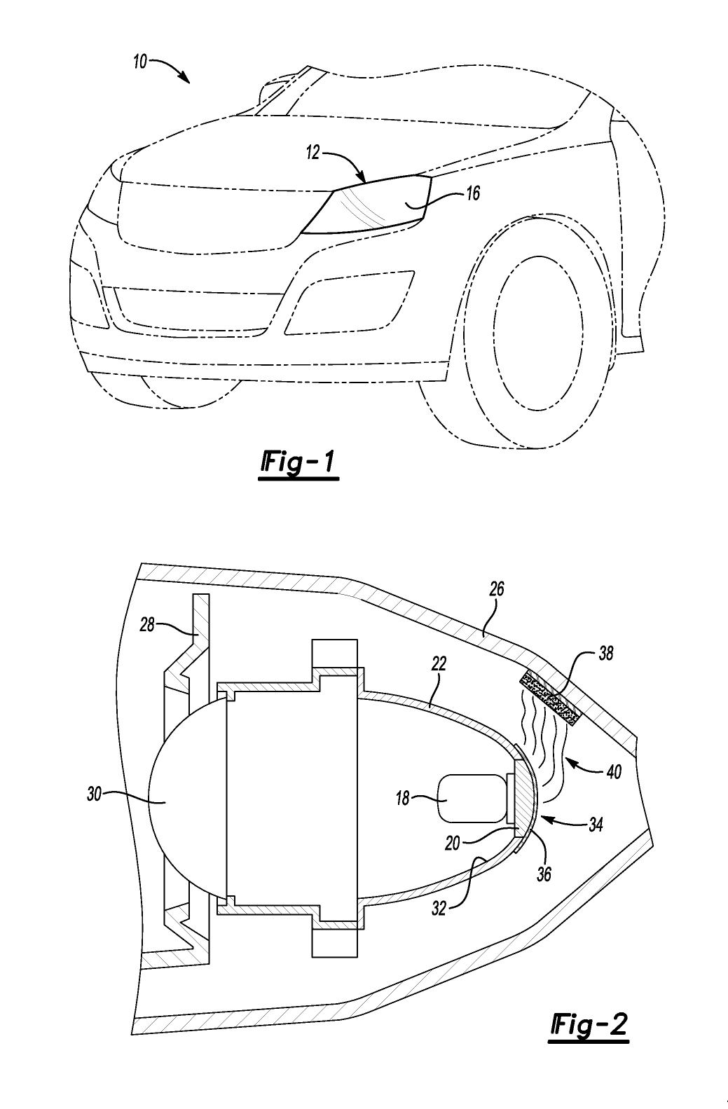

Referring to FIG. 1, a vehicle 10 is shown in phantom lines with a lamp assembly 12 shown in solid lines. An outer lens 16 of the lamp assembly 12 is the only portion of the lamp assembly 12 shown in FIG. 1.

Referring to FIG. 2, one example of a lamp assembly 12 made according to this disclosure is illustrated that includes a single bulb 18, or light source. It should be understood that many current designs for lamp assemblies include several different light sources 18, or bulbs. The light sources 18 may include one or more of a headlight, a high beam light, or a turn signal light. The light source may be an incandescent light bulb, a diode light, a halogen projector light, a high intensity discharge light, or the like.

A power supply 20 may be required for a given light source depending upon the type of light source. With incandescent bulbs, the bulb 18 is generally the source of heat within the lamp assembly. With other types of lights, such as LED lights, the power supply 20 may be the principal source of heat within the lamp assembly 12.

A reflector 22 is used to reflect the light emitted from the bulb 18. In addition to the reflector 22, a housing 26 and bezel 28 enclose and support the reflector 22 and light source 18. An inner lens 30 may be provided within the housing 26 in addition to the outer lens 16 of the lamp assembly 12. The reflector 22 has a reflective surface 32 that is provided to reflect the light emitted from the light bulb 18, or other light source.

An area of heat concentration is generally indicated by reference numeral 34 on the rear surface of the reflector 22 in the illustrated embodiment. The area of heat concentration 34 may be created by the bulb 18 or power supply 20. The reflector 22 may be formed of a thermoset polymer resin having thermal emissivity of less than 0.75.

A conductive surface 36 is provided at the area of heat concentration 34. The conductive surface illustrated is an aluminized coating. Alternatively, the conductive surface 36 may be an insert or attachment. For example, a metal insert, or high conductivity polymer insert or overlay, may be attached to the backside of the reflector 22. The conductive surface 36, shown in the drawings, should be understood to be either a coating or an insert.

An absorptive surface 38 may be provided within the housing 26. The housing 26 may be formed of a thermoset polymer resin having thermal absorptivity of less than 0.8.

The absorptive surface 38 may be a coating of flat black paint that is applied to an inside surface of the housing 26 or the bezel 28. The absorptive surface 38 may be located above the area of heat concentration 34 and also above the conductive surface 36. Convective air flow represented by the lines 40 is induced by the conductive surface 36 and the absorptive surface 38 that is preferably located above the conductive surface 36.

The absorptive surface 38 preferably has thermal absorptivity of more than 0.8 and may be at least 0.95. The conductive surface 36 preferably has thermal emissivity of more than 0.75 and may be at least 0.9 with a thermal conductivity of 12 watts per meter Coulomb (W/mC).

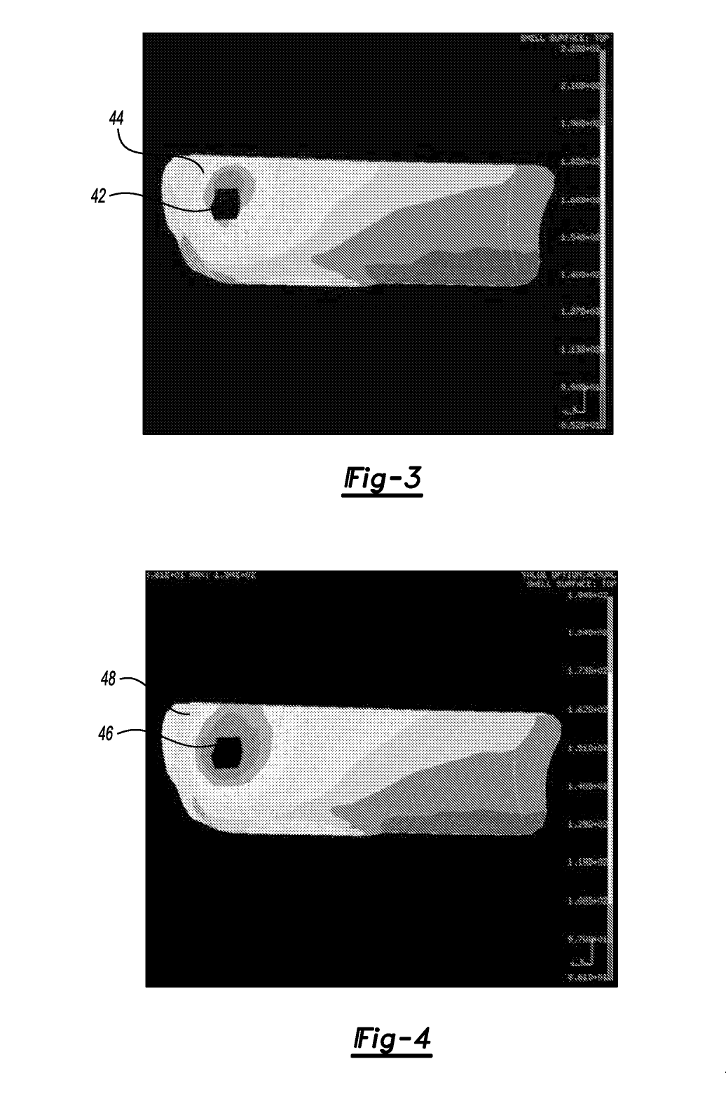

Referring to FIG. 3, a diagrammatic representation of a simulated lamp assembly is provided that does not include a conductive surface applied to an area of high heat concentration. For comparison purposes, FIG. 4 is a graphic representation of a temperature profile of a lamp assembly identical to the lamp assembly shown in FIG. 3 that has a highly conductive surface applied to an area of high heat concentration.

Referring to FIG. 3, a maximum heat concentration area 42 is shown that has a simulated area of maximum heat concentration having a simulated temperature of 223° C. when the light source is illuminated. An area of dissipated heat 44 is shown as the lighter shaded portion surrounding the area of maximum heat concentration 42.

Referring to FIG. 4, an area of maximum heat concentration 46 is shown to be a larger area as compared to the maximum heat concentration area 42 shown in FIG. 3. In addition, a dissipated heat area 48, shown in lighter shading, surrounds the area of maximum heat concentration 46. After application of the conductive surface to the back of the reflector 22, the temperature of the area of maximum heat concentration 46 was simulated to have been reduced to a temperature of 194° C.

In the simulation shown in FIGS. 3 and 4, the only change was the inclusion of a conductive surface on the rear portion of the reflector 22. As shown in FIG. 2, an absorptive surface 38 is applied to a surface inside the housing 26. Air flow 40 within the housing 26 is enhanced by including both the conductive surface 36 and the absorptive surface 38 above the conductive surface 36 to increase the convective heat flow within the lamp assembly 12.

The relative location of the conductive coating and the absorptive surface 38 will vary depending upon the exact design and structure of the lamp assembly 12. A plurality of conductive surfaces 36 may be provided wherever an area of heat concentration is identified. A plurality of absorptive surfaces 38 may be provided within the housing 26 or on the bezel 28 of the lamp assembly 12. Generally, the absorptive surface 38 is provided at a location above the conductive surface 36.

The disclosed method is used to reduce a temperature of an area of heat concentration 34 in a lamp assembly 12 including a lamp housing 26, a light source 18 (that may or may not include an associated power supply 20 within the lamp housing 22) and a reflector. According to one aspect of the method, a conductive surface 36 having emissivity of more than 0.75 is applied or attached to the area of heat concentration 34. According to the method, an aluminized surface coating may be painted, sprayed, or otherwise applied on a back surface of the reflector 32. Alternatively, an insert or overlay having a thermal conductivity of at least 0.9 watts per meter Coulomb may be attached to the reflector 22 or other area of heat concentration 34.

In addition, the method may include providing an absorptive surface 38, such as flat black paint on a portion of the housing 36 or bezel 28. The absorptive surface 38 may have absorptivity of more than 0.8.

According to the method, the absorptive surface may be located above the conductive surface 36 to induce additional convective area flow 40 from the conductive surface 36 to the absorptive surface 38. When the light source is illuminated, convective air flow is created within the lamp assembly 12. Passive radiation heat transfer is used to reduce the temperature of the area of heat concentration.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle lamp assembly comprising:
a lamp housing;
a light source disposed within the housing; and
a reflector having a thermal emissivity T₁ and is disposed within the housing; and
a conductive surface having a thermal emissivity T₂ that is positioned at an area of heat concentration on the reflector, wherein T₂ is greater than T₁.

2. The vehicle lamp assembly of claim 1 wherein the lamp housing has a thermal absorptivity T₁ and an absorptive surface having a thermal absorptivity T₂, wherein T₂ is greater than T₁.

3. The vehicle lamp assembly of claim 2 wherein the absorptive surface is a coating of black paint.

4. The vehicle lamp assembly of claim 2 wherein the absorptive surface has an absorptivity of at least 0.8.

5. The vehicle lamp assembly of claim 1 wherein the conductive surface is an aluminized coating.

6. The vehicle lamp assembly of claim 1 wherein the conductive surface has emissivity of at least 0.75.

7. The vehicle lamp assembly of claim 1 wherein the conductive surface is an insert having a thermal conductivity of 12 watts per meter Coulomb (W/mC).

8. The vehicle lamp assembly of claim 7 wherein the light source and a power source are supported by the reflector and create the area of heat concentration.

9. The vehicle lamp assembly of claim 1 wherein an absorptive surface is located on an inside surface of the lamp housing.

10. The vehicle lamp assembly of claim 9 wherein the conductive surface and the absorptive surface are positioned to create air circulation within the housing, reducing a temperature in the area of heat concentration by convective heat transfer.

11. The vehicle lamp assembly of claim 10 wherein convective heat transfer creates a convective air flow by passive radiation heat transfer during operation of the light source to reduce the temperature at the area of heat concentration.

12. A method of reducing a temperature of an area of heat concentration in a lamp assembly that includes a lamp housing, a light source and a reflector, wherein the area of heat concentration is formed of a material having thermal emissivity of T₁, the method comprising:
providing a surface at the area of heat concentration having thermal emissivity of T₂ that is more than T₁.

13. The method of claim 12 wherein the surface is an aluminized surface coating.

14. The method of claim 12 wherein the surface is an insert having thermal conductivity of at least 0.9 watts per meter Coulomb.

15. The method of claim 12 wherein a portion of the lamp assembly has thermal absorptivity of T₁, the method further comprising:
providing an absorptive surface within the lamp assembly having thermal absorptivity T₂ that is more than T₁ at a location above the surface.

16. The method of claim 15 wherein the absorptive surface is spaced apart from the surface.

17. The method of claim 15 wherein the absorptive surface is a coating of black paint.

18. The method of claim 12 further comprising:
illuminating the light source to create convective air flow within the lamp assembly using passive radiation heat transfer to reduce the temperature of the area of heat concentration.

19. A method of reducing an area of heat concentration in a lamp assembly that includes a lamp housing, a light source and a reflector, the method comprising:
providing an absorptive surface having absorptivity of more than an inherent absorptivity of a portion of the housing that the absorptive surface is provided on and is spaced above the area of heat concentration.
